(19) United States
(12) Patent Application Publication
(10) Pub. No.: US 2023/0375124 A1
(43) Pub. Date: Nov. 23, 2023

(54) COUPLING MECHANISM FOR ATTACHING A POWER-GENERATING SOURCE TO A TOWER AND A SYSTEM THEREOF

(71) Applicant: Revayu Systems Private Limited, New Delhi (IN)

(72) Inventor: Prateek Kumar Gupta, Greater Noida (IN)

(21) Appl. No.: 18/198,348

(22) Filed: May 17, 2023

Related U.S. Application Data
(60) Provisional application No. 63/343,514, filed on May 18, 2022.

(51) Int. Cl. F16M 7/00; F03D 9/25

(52) U.S. Cl. CPC F16M 7/00; F03D 9/25; F16M 2200/068; F16M 2200/08; F05B 2220/706

(57) ABSTRACT

The present disclosure relates to a coupling assembly for attaching a power generating source to a structure and a system thereof. The coupling assembly comprises at least one shaft having a first end and a second end and a support structure having a top portion and a bottom portion. The at least one shaft is configured to be attached to the power generating source at the first end. The support structure is configured to receive at least a portion of the at least one shaft at the second end on the top portion therein. The support structure is further configured to be attached to the structure at the bottom portion. The coupling mechanism is configured to provide support and stability to the power generating source. The system is configured to generate electrical energy which may be utilized to provide power to a tower.

### CROSS REFERENCE TO RELATED APPLICATIONS

This patent application claims priority benefit of U.S. Provisional Patent Application No. 63/343,514, entitled “COUPLING ASSEMBLY FOR ATTACHING A POWER-GENERATING SOURCE TO A STRUCTURE AND A SYSTEM THEREOF”, filed on May 18, 2022. The entire content of the patent application is hereby incorporated by reference herein in its entirety.

### FIELD OF THE DISCLOSURE

The present disclosure generally relates to a coupling assembly. More particularly, the present disclosure relates to a coupling assembly for attaching a power generating source to a structure and a system for generating electrical energy using the power generating source.

### BACKGROUND

Use of alternate sources of energy, such as solar panels, wind turbines, hydro power plants, tidal power plants, biofuel plants, geothermal energy, and the like, have been increased recently to a significant amount. Continuous research is being conducted to use renewable sources of energy in novel ways so that more amount of energy can be produced using such renewable sources. There are certain requirements which need to be satisfied for getting maximum efficiency in energy generation using such renewable sources, such as location of installation, optimum weather conditions, and the like. Also, installation of such renewable sources is highly expensive. Reducing cost of installation is an important factor of consideration for use of such renewable sources.

Recently, some of the renewable energy sources, such as wind turbines, are installed over towers, such as transmission towers or telecom towers. Such installation provides advantage of high altitude of the wind turbines which helps in producing more electrical energy. Such wind turbines are attached using a special attachment mechanism. Such attachment mechanism attaches or couples the wind turbine with a tower. One of the limitations associated with the currently available attachment mechanism is lack of stability. In case of bad weather, such as in situations of cyclones, currently available attachment mechanisms tend to bend or be disengaged with the tower, thereby affecting the overall performance of power generation mechanism.

Hence, there is a need of an attachment mechanism which provides more stability and is less affected by bad weather conditions.

### SUMMARY

While the way in which the present disclosure addresses the disadvantages of the prior art will be discussed in greater detail below, in general, the present disclosure provides a coupling assembly for attaching a power-generative source to a structure and a system thereof.

An object of the present disclosure is to provide a coupling assembly for attachment of a wind turbine to a tower.

Another object of the present disclosure is to provide a coupling assembly which provides high stability to the attachment.

Yet another object of the present disclosure is to provide a coupling assembly which is light weight.

Yet another object of the present disclosure is to provide a coupling assembly which has high tensile strength.

Further object of the present disclosure is to provide a coupling assembly which produces less vibration in bad weather conditions.

Yet another object of the present disclosure is to provide a coupling assembly which uses one or more shafts.

Further object of the present disclosure is to provide a coupling assembly which has one or more shafts having an outer periphery in polygonal shape.

Yet another object of the present disclosure is to provide a coupling assembly which has one or more shafts having an outer periphery in a hexagonal shape or an octagonal shape.

Further object of the present disclosure is to provide a coupling assembly which has a support structure for attaching one or more shafts with a structure.

Yet another object of the present disclosure is to provide a coupling assembly having a support structure which has at least one securing member thereof for receiving and securing at least a portion of one or more shafts.

A coupling assembly in accordance with the present disclosure comprises at least one shaft having a first end and a second end and a support structure having a top portion and a bottom portion. The at least one shaft is configured to be attached to the power generating source at the first end. The support structure is configured to receive at least a portion of the at least one shaft at the second end on the top portion therein. The support structure is further configured to be attached to the structure at the bottom portion.

The at least one shaft may be configured to have an outer periphery in a polygonal shape. The at least one shaft may be further configured to have an outer periphery in a hexagonal shape or an octagonal shape.

The support structure may comprise at least one securing member on the top portion thereof for receiving and securing at least the portion of the at least one shaft at the second end. The at least one securing member may be in a form of receptacle that is configured to receive at least the portion of the at least one shaft at the second end therein. A shape of the at least one securing member corresponds to a shape of the outer periphery of the at least one shaft.

The support structure may comprise a plurality of arms extending from a central portion thereof. The plurality of arms may be configured to be attached to the central portion at an angle with respect to a longitudinal axis (L) of the at least shaft extending from the first end to the second end.

The support structure may further comprise a plurality of legs for secure connection with the top of the tower. The plurality of legs may be present at the bottom portion thereof, each of the plurality of legs extending downwardly from each of the plurality of arms.

The at least one shaft is made of a material having lightweight and high tensile strength.

The at least one shaft may be a hollow structure.

The at least one shaft may comprise a plurality of shafts. In one embodiment, each of the plurality of shafts may be configured to be arranged parallel to each other. In another embodiment, the plurality of shafts are configured to be arranged serially, such that, a second end of a first shaft abuts a first end of a second shaft. In yet another embodiment, the plurality of shafts are configured to be arranged in combination of a serial arrangement and a parallel arrangement.

The present disclosure further discloses a power generating system comprising a wind turbine and a coupling assembly for attaching the wind turbine. The coupling assembly comprises at least one shaft having a first end and a second end, and a support structure having a top portion. The support structure being configured to receive and secure at least a portion of the at least one shaft at the second end on the top portion therein.

The present disclosure further discloses a system for generating electrical energy. The system comprises a power generating source and a coupling assembly for attaching the power generating source to a structure. The power generating source may be a wind turbine. The wind turbine may be a horizontal axis wind turbine. The structure may be a tower. The tower may be a transmission tower or a telecom tower. The coupling mechanism may be used as attachment between the wind turbine and the tower. The electrical energy generated by the wind turbine may be utilized by the tower or may be fed to a power grid.

### BRIEF DESCRIPTION OF THE DRAWINGS

The foregoing and other features of this disclosure will become more fully apparent from the following description and appended claims, taken in conjunction with the accompanying drawings. Understanding that these drawings depict only several embodiments in accordance with the disclosure and are, therefore, not to be considered limiting of its scope, the disclosure will be described with additional specificity and detail through use of the accompanying drawings, in which:

FIG. 1 is a front view of an exemplary coupling assembly in accordance with the present disclosure.

FIG. 2 illustrates an exemplary block diagram of a system for generating electrical energy in accordance with the present disclosure.

FIGS. 3A and 3B illustrate a perspective view and a cross-sectional top view of a first exemplary shaft in accordance with the present disclosure.

FIGS. 4A and 4B illustrate a perspective view and a cross-sectional top view of a second exemplary shaft in accordance with the present disclosure.

FIG. 5 illustrates a perspective view of an exemplary support structure in accordance with the present disclosure.

FIG. 6 illustrates a front view of an exemplary coupling assembly with a plurality of shafts that are arranged parallelly in accordance with the present disclosure.

FIG. 7 illustrates a front view of an exemplary coupling assembly with a plurality of shafts that are arranged serially in accordance with the present disclosure.

FIG. 8 illustrates a front view of an exemplary coupling assembly with a plurality of shafts that are arranged in combination of a serial arrangement and a parallel arrangement accordance with the present disclosure.

### DETAILED DESCRIPTION

The following description is of exemplary embodiments of the invention only, and is not intended to limit the scope, applicability, or configuration of the invention. Rather, the following description is intended to provide a convenient illustration for implementing various embodiments of the invention. As will become apparent, various changes may be made in the function and arrangement of the elements described in these embodiments without departing from the scope of the invention as set forth herein. It should be appreciated that the description herein may be adapted to be employed with alternatively configured devices having different shapes, components, attachment mechanisms and the like and still fall within the scope of the present invention. Thus, the detailed description herein is presented for purposes of illustration only and not of limitation.

Reference in the specification to “one embodiment” or “an embodiment” is intended to indicate that a particular feature, structure, or characteristic described in connection with the embodiment is included in at least an embodiment of the invention. The appearances of the phrase “in one embodiment” or “an embodiment” in various places in the specification are not necessarily all referring to the same embodiment.

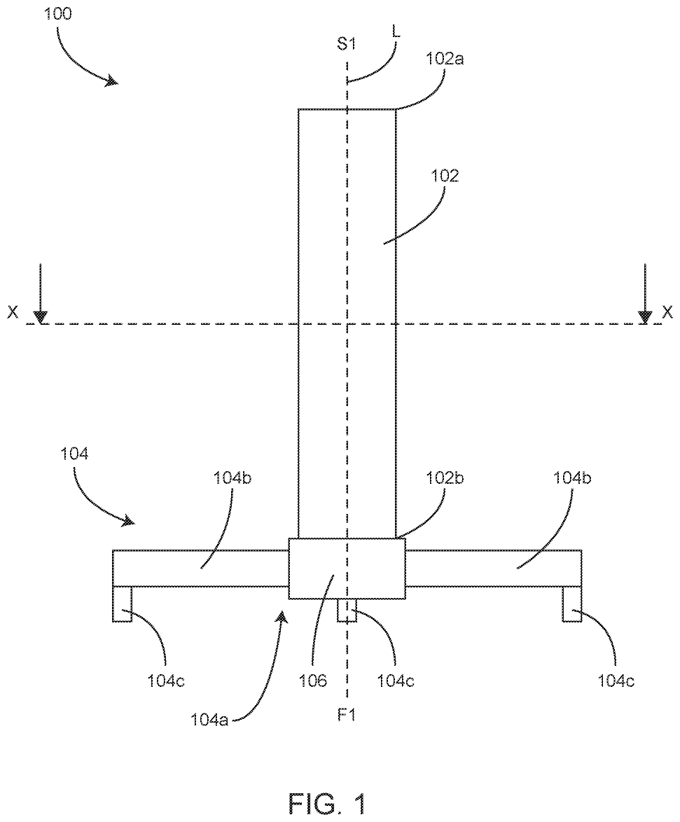

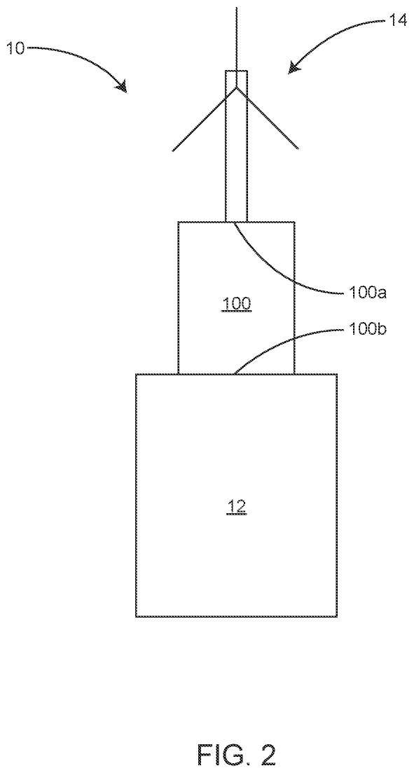

Reference is initially made to FIG. 1 which illustrates an exemplary coupling assembly 100 according to one embodiment of the present disclosure. The coupling assembly 100 may be configured to couple a power generating source to a structure. The structure refers to a physical structure such as a tower, a building, a bridge, a dam, a water tank, and the like. The power generating source may be a wind turbine, a solar plant, a geothermal power plant, a hydropower plant, a tidal power plant and the like. In an exemplary embodiment, the coupling assembly 100 may be configured to couple a wind turbine 14 to a tower 12 (seen in FIG. 2). In some embodiments, the wind turbine 14 is any one of a horizontal axis wind turbine (HAWT), and a vertical axis wind turbine (VAWT). In some exemplary embodiments, the tower may be a transmission tower, a telecom tower, a watch tower, a bell tower, a water tower, a light house, a chimney, a cooling tower, any observation tower, any vertical structure, and the like. In case of the transmission tower or the telecom tower, the tower may be a lattice tower, a monopole tower, a hybrid tower, a guyed tower, a tubular tower and the like.

In an embodiment, in addition to coupling the power generating source to the structure, the coupling assembly 100 may further be configured to facilitate transmission of electrical energy generated by the power generating source to the structure or a power grid.

It is submitted that the invention has been explained with reference to a wind turbine as a power generating source and a tower as a structure; it is appreciated that the invention is not limited to wind turbines and towers and is equally applicable for other types of power generating sources and structures.

As seen in FIG. 1, the coupling assembly 100 comprises at least one shaft 102 and a support structure 104. The at least one shaft 102 is configured to facilitate coupling between the power generating source and the support structure 104. At least one shaft 102 comprises a longitudinal axis (L) extending from a first side (F1) and a second side (S1) in a vertical direction. The support structure 104 is configured for supporting and attaching to the at least one shaft 102, and further, facilitating coupling of the at least one shaft 102 to the structure. In some embodiments, the coupling assembly 100 is configured to facilitate coupling between the wind turbine 14 and the tower 12. The shaft 102 may be disposed between the wind turbine 14 and the tower 12 and may be configured to support the wind turbine 14. It is to be understood that the wind turbine 14 includes a plurality of blades, a hub connected to blades and shaft, a generator, a gear box, drive shafts, a nacelle that houses the generator, the gear box and the like, and other components necessary for converting kinetic energy of wind into the electrical energy.

In an embodiment, the coupling assembly 100 may comprise a single shaft 102 disposed between the power generating source and the structure. In one exemplary embodiment, the coupling assembly 100 may comprise a single shaft 102 disposed between the wind turbine 14 and the tower 12. Although a single shaft 102 has been illustrated in FIG. 1, it is appreciated that the coupling assembly 100 may comprise a plurality of shafts 102 as will be detailed below. Further, the details related to a single shaft 102 is applicable for each of the plurality of shafts 102 in the coupling assembly 100.

Referring to FIG. 2, the coupling assembly 100 is configured to couple the power generating source, in this case the wind turbine 14 to the structure, in this case the tower 12. The system 10 may be configured for generating electrical energy using the power generating source, such as the wind turbine 14. The coupling assembly 100 is disposed between the wind turbine 14 and the tower 12. The coupling assembly 100 comprises a first end 100a and a second end 100b. The coupling assembly 100 may be attached to the wind turbine 14 at the first end 100a. The coupling assembly 100 may be configured to couple with the tower 12 at the second end 100b. In an embodiment, the tower 12 may be a telecom tower. In other embodiment, the tower 12 may be a transmission tower.

Referring back to FIG. 1, in an embodiment, each of the plurality of the shafts 102 may comprise a first end 102a and a second end 102b. The at least one shaft 102 is configured to be attached or coupled to the power generating source at the first end 102a using a mounting assembly. In one example, the at least one shaft is configured to be attached to the wind turbine 14 at the first end 102a. The mounting assembly (not shown) may comprise a mounting bracket or a mounting flange with predrilled holes at the first end 102a and the second end 102b of each of the plurality of the shafts 102. In an example where the coupling assembly 100 with the single shaft 102, the mounting flange at the first end 102a of the at least one shaft 102 is bolted against a matching flange with predrilled holes in the power generating source. The mounting flange may be integrally formed along with the shaft 102 or formed separately and welded with the shaft 102. In some embodiments, the first end 102a may comprise a threaded portion that is tightened or loosened with a matching thread in the power generating source. The matching flange or matching threaded may be, not limited to, present in the nacelle if the wind turbine 14 is attached to the first end 102a of the at least one shaft 102. It is to be noted that above disclosed mounting mechanism or assembly does not limit the scope of the invention. Any suitable mounting assembly or mechanism is used to attach the at least one shaft 102 with the power generating source.

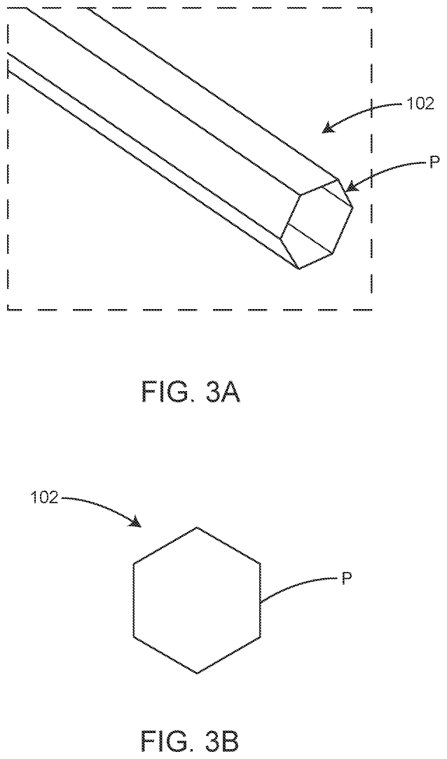

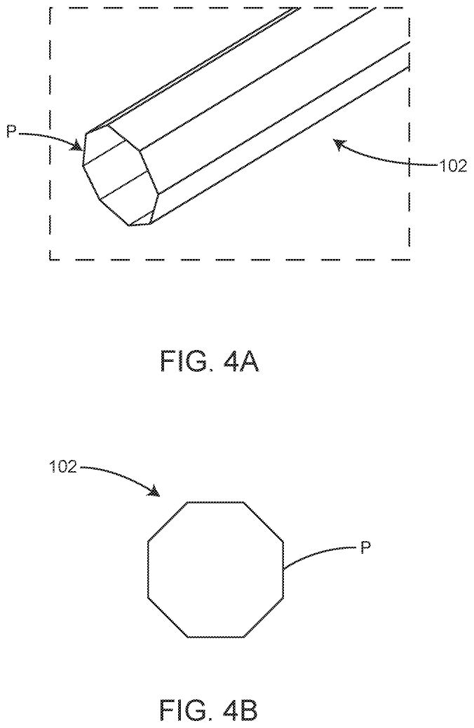

In an embodiment, each of the shafts 102 may have an outer periphery of a polygonal shape. Non limiting examples of polygonal shape includes triangle, quadrilateral, pentagon, hexagon heptagon octagon nonagon, and decagon. In one exemplary embodiment, each of the shafts 102 may have an outer periphery of a hexagonal shape or an octagonal shape. The hexagonal shape or the octagonal shape of the outer periphery may be configured to provide more stability to the plurality of the shafts 102. Reference is made to FIGS. 3A and 3B that illustrate a perspective view and a cross-sectional top view of a first exemplary shaft 102 to illustrate a periphery of the shaft 102. The cross-section may be considered as being taken along line X-X in FIG. 1. As seen in FIGS. 3A and 3D, the shaft 102 may have a periphery P resembling the shape of a hexagon as a number of sides of the shaft 102 is six. Reference is made to FIGS. 4A and 4B that illustrate a perspective view and a cross-sectional top view of a second exemplary shaft 102 to illustrate a periphery of the shaft 102. As seen in FIGS. 4A and 4B, the shaft 102 may have a periphery P resembling the shape of an octagon as a number of sides of the shaft 102 is eight. Hence, in circumstances of bad weather, such as in condition of strong winds and cyclone, the shafts 102 are less affected. Such outer periphery P enhances resistance for facing strong wind, and hence, such shafts 102 are prevented from bending due to the forced exerted by such strong winds.

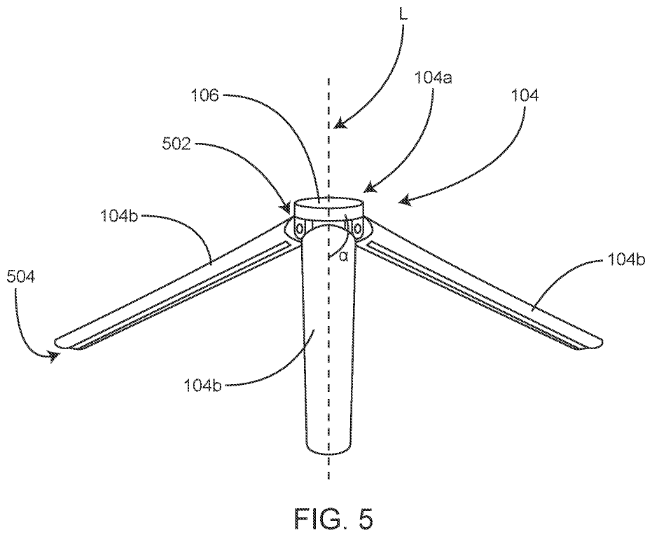

The support structure 104 is configured to receive at least a portion of the at least one shaft 102 at the second end 102b on the top portion 108 therein. Accordingly, the shaft 102 is attached between the power generating source and the support structure which in turn attached to the structure. The support structure 104 may comprise a center portion 104a and a plurality of arms 104b protruding radially from the center portion 104a. The center portion 104a of the support structure 104 refers to a central part of the support structure 104 that connects the plurality of arms 104b together. It is usually a hub or a platform that serves as a stable base for the arms 104b to attach and provides stability and balance to the coupling assembly 100. That is, the support structure 104 may be of a shape having a plurality of arms 104b protruding from the center portion 104a of the support structure 104. In the illustrated embodiment, the support structure 104 is configured to have three arms 104b protruding from the center portion 104a. Each of the plurality of the arms 104b comprises a proximal end 502 that is closest to the center portion 104a and a distal end 504 that is opposite to the proximal end 502 (Seen in FIG. 5). Each of the plurality of arms 104b extends radially from the proximal end 502 attached to the central portion 104a to the distal end 504. The plurality of arms 104b are configured to be attached to the central portion 104a at an angle (a) with respect to a longitudinal axis (L) of the at least shaft 102 extending from the first end 102a to the second end 102b. It is to be noted that a radial angle between the plurality of arms 104b depends on the number of the plurality of arms 104b. For instance, in case of three arms, the radial angle between the arms is 120°. In case of four number of arms, the radial angle between two consecutive arms is 90°, and so on.

In an embodiment, each of the plurality of arms 104b is attached to the center portion 104a at one of the ends thereof so as to protrude radially therefrom. It is to be noted that any suitable attaching or fastening means is used to the attach each arm 104b to the center portion 104a. For example, the center portion 104a comprises an opening with predrilled holes therein in which each of arms with matching holes is inserted and bolted. Optionally, the plurality of arms 104b and the central portion 104c may be molded or welded together.

Each of the plurality of arms 104b may comprise a leg 104c, at the other end such the distal end 504, extending downwardly, i.e., in a direction towards the structure such as the tower 12 when the coupling assembly 100 is coupled to the structure. The legs 104c may be configured to engage with the structure so that the support structure 104 is securely attached with the structure. In an embodiment, the legs 104c are configured to engage with a top portion of the structure. Thus, the legs 104c may define the second end 100b of the coupling assembly 100. The legs and the top portion of the structure are securely attached or coupled using a suitable mechanical coupling or mounting means (not shown). For example, flange mounting, hinge mounting, and the like may be used. Such secure attachment provides stability to the coupling assembly 100 while connected with the structure. Hence, a standing strength and steadiness of the structure may be utilized to provide stability to the coupling assembly 100. As a result, there is no need of special stability provisions to the coupling assembly 100, and hence, to the power generating source or wind turbine 14.

In an embodiment, the support structure 104 may comprise at least one securing member 106 at an upper portion thereof, the at least one securing member 106 being configured to be secured to the shafts 102 at the second ends 102b of the shafts 102. In an embodiment, the securing member 106 may be in the form of receptables configured to receive the second end 102b of a corresponding shaft 102 therewithin.

In an embodiment, a shape of the securing member 106 corresponds to the outer periphery of a corresponding shaft 102 such that the securing member 106 securely engage with the corresponding shafts 102. In other words, in case the outer periphery of the shafts 102 is of a hexagonal shape, the securing member 106 may also be of a hexagonal shape. In case the outer periphery of the shafts 102 is of an octagonal shape, the securing member 106 may also be of the octagonal shape. It is appreciated that the securing member may have a shape other than the hexagonal shape or the octagonal shape.

In an embodiment, a first depth of the securing member 106 is such that to accommodate the corresponding shafts 102 firmly therewithin. In other words, the shafts 102 may be received by the corresponding securing member 106 such that the shafts 102 are able to withstand strong wind or even cyclone, without disengaging or altering a connection between the shafts 102 and the corresponding securing means in any way. Each shaft 102 and each securing member 106 are coupled or attached using a suitable mechanical coupling or attaching member. For example, nuts and bolts may be used to couple the second end 102b of the shaft 102 and the securing member 106.

One non-limiting example of the support structure 104 is a tripod having three arms 104b (seen in FIG. 5). The arms 104b in the tripod may be equally space around the center of the support structure 104. Accordingly, an angle between each of the arms 104b in the tripod is 120 degrees. In an embodiment, the plurality of arms 104b may be equally spaced around the center of the support structure 104. Hence, an angle between each of the plurality of arms 104b may be same. However, it is to be understood that any two or all of the plurality of the arms 104b may have different angles therebetween. It is to be noted that the tripod is an example of the support structure 104 and any support structure 104 having functionality as described above may be used as a support structure 104. It is to be noted that a number of arms 104b to be used, angle of each arm 104b with respect to the longitudinal axis (L), distance between each arm 104b depend on at least one following parameter such as a type of a power generating source, a size and design of the power generating source, a type of the structure, a size and design of the structure, weather condition or combination thereof.

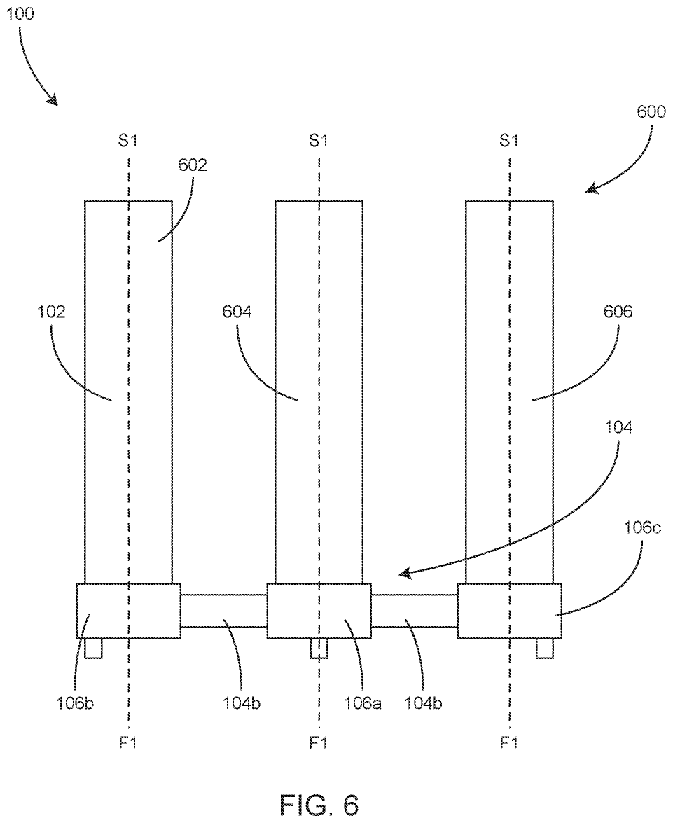

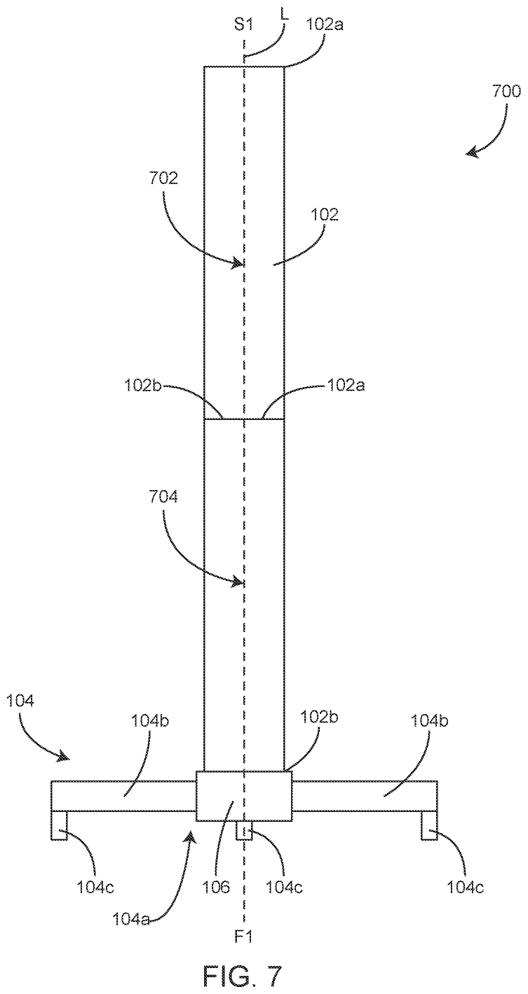

In an embodiment, the coupling assembly 100 comprises a plurality of shafts 102. In one embodiment, the plurality of shafts 102 are configured to be arranged in a parallel arrangement (seen in FIG. 6). That is, each of the plurality of shafts 102 may be arranged to be parallel to one another and provide support to the power generating source. As an example, the coupling assembly 100 may comprise three or four shafts 102 arranged parallel to one another. In another embodiment, the plurality of shafts 102 are configured to be arranged in a serial arrangement (seen in FIG. 7). The plurality of shafts 102 may be arranged coaxially between the wind turbine 14 and the tower 12 such that the longitudinal axis L of each of the one or more shafts 102 coincide. In other words, the plurality of shafts 102 may be arranged on top of one another vertically between the power generating source and the structure. In such arrangement, a height of the overall shaft of the coupling assembly 100 formed by serial, coaxial arrangement of the plurality of shafts 102 is equal to a sum of individual height of the plurality of shafts 102 arranged coaxially. Hence, the height of the coupling assembly 100 with the plurality of shafts 102 in a serial, coaxial arrangement is larger as compared to the coupling assembly 100 with a single shaft 102 and the coupling assembly 100 with a plurality of shafts 102 in the parallel arrangement.

Now reference is made to FIG. 6 which illustrates a front view of an exemplary coupling assembly 600 with a plurality of shafts 102 that are arranged parallelly in accordance with the present disclosure. In the parallel arrangement, each of the shafts 102 may be configured to be coupled to the power generating source such as the wind turbine 14 at the respective first ends 102a using the mounting assembly. Accordingly, the respective first ends 102a of the shafts 102 define the first end 100a of the coupling assembly 100. Accordingly, the plurality of shafts 102 provide support to the wind turbine 14. In FIG. 6, four shafts 602, 604, 606, and 608 (not shown) are used and are arranged parallel to each other. Such that first end 102a of each shaft 602, 604, 606, and 608 is attached to the power generating source such as the wind turbine 14. It is to be noted that above disclosed number of shafts does not limit the scope of the present disclosure.

Now reference is made to FIG. 7 which illustrates a front view of an exemplary coupling assembly 700 with a plurality of shafts 102 that are arranged serially in accordance with the present disclosure. The plurality of the shafts 102 may be coupled to one another in a coaxial manner along the respective longitudinal axis L. Accordingly, when the plurality of the shafts 102 are arranged serially, the first end 102a of the upper most shaft 102 such as a first shaft, i.e., the shaft 102 closest to the power generating source defines the first end 100a of the coupling assembly 100 and couples with the power generating source using the mounting assembly. Further, a second end 102b of the first shaft abuts a first end 102a of a subsequent shaft such as a second shaft. Similarly, the second 102b of the second shaft abuts a first end 102a of a third shaft. In another words, the shaft 102 is arranged one above another vertically, thereby the longitudinal axis (L) of each of the plurality of shafts 102 coincide. In FIG. 7, two shafts 702 and 704 are used and are arranged serially or coaxially one above another. Such that a first end 102a of a first shaft 702 is attached to the power generating source such as the wind turbine 14 and a second end 102b of the first shaft 702 is attached or coupled with a first end 102a of a second shaft 704. It is to be noted that above disclosed number of shafts does not limit the scope of the present disclosure.

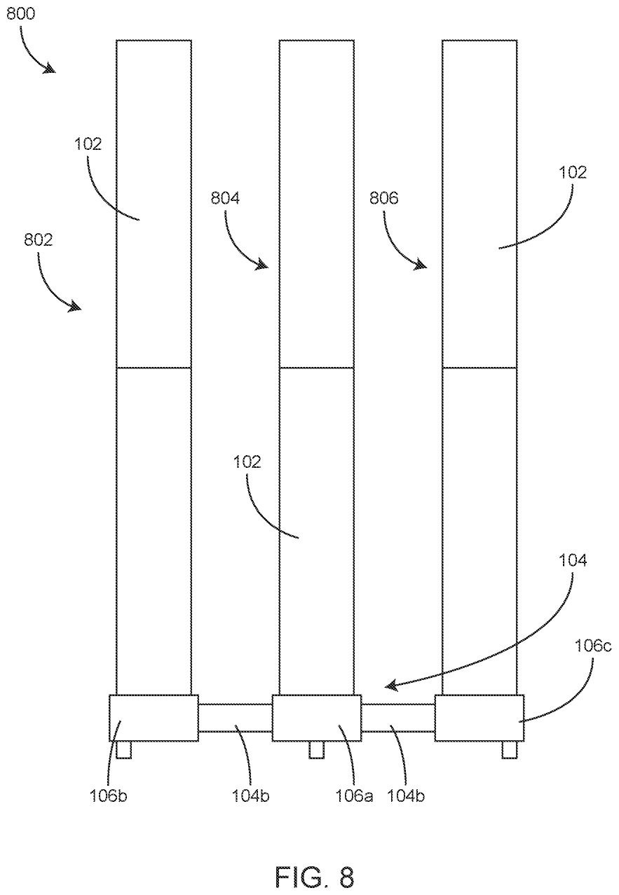

Now reference is made to FIG. 8 which illustrates a front view of an exemplary coupling assembly 800 with a plurality of shafts 102 that are arranged in combination of a serial arrangement and a parallel arrangement accordance with the present disclosure. The plurality of shafts 102 are arranged in a combination of serial and parallel arrangement (Seen in FIG. 8). For instance, shafts 102 may be arranged in a serial arrangement such as 802, 804, and 806, and two or more of such serially arranged shafts 802, 804, and 806 may be arranged in a parallel arrangement between the wind turbine 14 and the tower 12, thereby forming the mixed arrangement of the coupling assembly 100.

In an embodiment, the plurality of the shafts 102 may be coupled with each other, and with the wind turbine 14 using fasteners. Some non-limiting examples of fasteners may include a flange, a nut and bolt coupling, and the like. Accordingly, the first ends 102a of the shafts 102 may include fastening units (not shown) by virtue of which the shafts 102 are coupled to each other and/or to the wind turbine 14 using the fasteners.

It is to be noted that a number of shafts 102 to be used and an arrangement of the shaft such parallel arrangement, serial arrangement, or combination thereof depend on at least one following parameter such as a type of a power generating source, a size and design of the power generating source, a type of the structure, a size and design of the structure, weather condition or combination thereof. For example, in the case of the wind turbine 14, a type of wind turbine, a number of blades, a type of the tower, a size and design of the tower, weather condition or combination thereof may be considered to select the number of shafts 102 and the arrangement of the shafts 102.

Further, It is to be noted that a number of the securing member 106 corresponds to a number of shafts 102 being used in the coupling assembly 100. For example, if the coupling assembly 100 comprises a single shaft 102, the support structure 104 may have a single securing member 106, for instance at the center portion 104a of the support structure 104, from where the plurality of arm 104b protrude or extend. As in FIG. 6 the plurality of shafts are used, therefore a plurality of securing members 106 are present at the center portion 104a and each of the plurality of arms 104b. Similarly, in FIGS. 7 and 8. a plurality of securing members 106 are used corresponding to a number of shafts 102 used.

Referring back to FIG. 2 which illustrates system 10 for generating electrical energy using the power generating source being a wind turbine 14, the system 10 is configured to generate more electrical energy as compared to conventional systems. According to the system 10 of the present disclosure, an effective height of the wind turbine 14 from the ground is more as compared to stand alone wind turbines. Hence, the wind turbine 14 of the system 10 is configured to produce more electrical energy. The ‘effective height’ may be referred as a total height of a height of the tower 12 and a height of the one or more shafts 102 of the coupling mechanism 100. Due to such design of the system 10 having a wind turbine 14 over a tower 12, more amount of natural wind may be captured by the wind turbine 14, and hence, the wind turbine 14 may generate more amount of electrical energy.

In some embodiments, the system 10 comprises a transmitting member (not shown) configured to transmit the electrical energy generated by the power generating source to the structure or a grid, through the at least one shaft 102, the at least one shaft being a hollow member through which the transmitting member transmits the electrical energy. The transmitting member may be power transmitting cables and other associated components which enables power transmission. In an exemplary embodiment, the electrical energy generated by the wind turbine 14 may be utilized to power the telecom tower 12 where the wind turbine 14 is attached. In an embodiment, the one or more shafts 102 may be configured to be hollow structure and may facilitate transmission of the generated electrical energy to the telecom tower 12 therethrough, which would reduce transmission loss of the generated electrical energy. Moreover, if the generated electrical energy is more than a requirement of telecom tower 12, the excess energy may be fed to a power grid.

The wind turbine 14 in accordance with the present disclosure is attached over the top of a tower 12. Hence, no separate space or installation is required for using the wind turbine 14 in accordance with the present disclosure as compared to the traditional wind turbines. Accordingly, the space is saved, which can be utilized for different usage. Also, cost of installation is saved as the present disclosure eliminates a cost of building and installing towers to support the wind turbines or other power generating sources. Hence, energy generation using the system 10 of the present disclosure is cost-effective.

In an embodiment, the system 10 may be configured to generate non-uniform AC power. The system 10 may comprise an AC-DC converter to generate a uniform DC power. The uniform DC power may be converted to a uniform AC power using a DC-AC converter. The generated uniform AC power may then be utilized to provide power to the telecom tower 12 or may be fed to a power grid.

Finally, while the present invention has been described above with reference to various exemplary embodiments, many changes, combinations, and modifications may be made to the exemplary embodiments without departing from the scope of the present invention. For example, the various components may be implemented in alternative ways. These alternatives can be suitably selected depending upon the particular application or in consideration of any number of factors associated with the operation of the device. In addition, the techniques described herein may be extended or modified for use with other types of devices. These and other changes or modifications are intended to be included within the scope of the present invention.

What is claimed is:

1. A coupling assembly for attaching a power generating source to a structure, comprising:
a) at least one shaft having a first end and a second end; and
b) a support structure having a top portion and a bottom portion, the support structure being configured to receive at least a portion of the at least one shaft at the second end on the top portion therein;
wherein the at least one shaft is configured to be attached to the power generating source at the first end and the support structure is configured to be attached to the structure at the bottom portion.

2. The coupling assembly as claimed in claim 1, wherein the at least one shaft is configured to have an outer periphery having a polygonal shape.

3. The coupling assembly as claimed in claim 1, wherein the at least one shaft is configured to have an outer periphery having any one of a hexagonal shape and an octagonal shape.

4. The coupling assembly as claimed in claim 1, wherein the support structure comprises at least one securing member on the top portion thereof for receiving and securing the portion of the at least one shaft at the second end.

5. The coupling assembly as claimed in claim 4, wherein the at least one securing member is at a central portion of the support structure, wherein the at least one securing member is in a form of receptacle that is configured to receive the at least portion of the at least one shaft at the second end therein, and wherein a shape of the at least one securing member corresponds to a shape of an outer periphery of the at least one shaft and is configured to have a first depth for accommodating the second end securely therein.

6. The coupling assembly as claimed in claim 4, wherein a number of the at least one securing member in the top portion of the support structure corresponds to a number of the at least one shaft to be used.

7. The coupling assembly as claimed in claim 1, wherein the support structure further comprises a plurality of arms extending from a central portion thereof, the plurality of arms configured to be attached to the central portion at an angle with respect to a longitudinal axis (L) of the at least shaft extending from the first end to the second end.

8. The coupling assembly as claimed in claim 7, wherein each of the plurality of arms comprises a proximal end and a distal end, wherein each of the plurality of arms extends radially from the proximal end attached to the central portion to the distal end.

9. The coupling assembly as claimed in claim 7, wherein the support structure further comprises a plurality of legs at the bottom portion thereof, each of the plurality of legs extending downwardly from each of the plurality of arms, wherein the plurality of legs are configured to be secured at a top portion of the structure, thereby attaching the power generating source to the structure.

10. The coupling assembly as claimed in claim 1, wherein the at least one shaft is a hollow structure, and is made of E450 grade steel.

11. The coupling assembly as claimed in claim 1, wherein the at least one shaft comprises a plurality of shafts corresponding first ends and second ends, each of the plurality of shafts having a longitudinal axis (L) extending from the first end to the second end, wherein the longitudinal axis (L) comprises a first side and a second side.

12. The coupling assembly as claimed in claim 11, wherein each of the plurality of shafts is configured to be arranged parallel to each other.

13. The coupling assembly as claimed in claim 11, wherein the plurality of shafts are configured to be arranged serially, such that, a second end of a first shaft abuts a first end of a second shaft.

14. The coupling assembly as claimed in claim 11, wherein the plurality of shafts are configured to be arranged in combination of a serial arrangement and a parallel arrangement.

15. The coupling assembly as claimed in claim 1, wherein the power generating source is a wind turbine.

16. The coupling assembly as claimed in claim 1, wherein the coupling assembly is made of a material having a light weight and a high tensile strength.

17. A power generating system, comprising;
a) a wind turbine; and
b) a coupling assembly for attaching the wind turbine, wherein the coupling assembly comprises:
i) at least one shaft having a first end and a second end; and
ii) a support structure having a top portion, the support structure being configured to receive and secure at least a portion of the at least one shaft at the second end on the top portion therein.

18. A system for generating electrical energy, comprising:
a) a power generating source configured for generating electrical energy; and
b) a coupling assembly configured for attaching the power generating source to a structure; wherein the coupling assembly comprises:
i) at least one shaft having a first end and a second end; and
ii) a support structure having a top portion and a bottom portion, the support structure being configured to receive and secure at least a portion of the at least one shaft at the second end on the top portion therein;
wherein the at least one shaft is configured to be attached to the power generating source at the first end and the support structure is configured to be attached to the structure at the bottom portion.

19. The system as claimed in claim 18, comprising a transmitting member configured to transmit the electrical energy generated by the power generating source to any one of the structure and a grid, through the at least one shaft, wherein the at least one shaft is a hollow member through which the transmitting member transmits the electrical energy.

20. The system as claimed in claim 18, wherein the support structure comprises at least one securing member on the top portion thereof for receiving and securing the at least the portion of the at least one shaft at the second end, and a plurality of arms extending from a central portion of the support structure.
